(19) United States
(12) Patent Application Publication
(10) Pub. No.: US 2026/0136439 A1
(43) Pub. Date: May 14, 2026

(54) CARBON NANOTUBE (CNT) FABRIC COMPOSITE HEATER FOR ICE PROTECTION WITH INTEGRATED HUMIDITY PROTECTION SHIELD

(71) Applicant: GOODRICH CORPORATION, Charlotte, NC (US)

(72) Inventors: Jin Hu, Cary, NC (US); Nathaniel Ching, Hartville, OH (US); Tyler Zadrozny, Akron, OH (US)

(73) Assignee: GOODRICH CORPORATION, Charlotte, NC (US)

(21) Appl. No.: 18/948,065

(22) Filed: Nov. 14, 2024

(51) Int. Cl. H05B 6/46

(52) U.S. Cl. CPC H05B 6/46

(57) ABSTRACT

A humidity protection shield assembly for a carbon nanotube (CNT) fabric composite heater assembly. The humidity protection shield assembly includes a first portion and a second portion. The CNT assembly is disposed between the first portion and the second portion. The first portion includes at least one of one or more first di-electric layers or one or more first thermoplastic/thermoplastic composite di-electric layers; at least one of a first carbon fiber layer or a first composite carbon fiber layer; and at least one of a first metal humidity layer or a first metalized film humidity layer. The second portion includes at least one of one or more second di-electric layers or one or more second thermoplastic/thermoplastic composite di-electric layers; at least one of a second carbon fiber layer or a second composite carbon fiber layer; and at least one of a second metal humidity layer or a second metalized film humidity layer.

### FIELD

The present disclosure generally relates to resistive heating systems and more specifically to a carbon nanotube (CNT) fabric composite heater for ice protection with integrated humidity protection shield.

### BACKGROUND

Carbon nanotubes (CNT) are cylindrical nanostructures composed of carbon atoms. CNT sheet is a material formed by depositing CNT on a flat sheet or on a drum and then unrolling the CNT. Being an allotrope of carbon, CNTs exhibit excellent electrical, thermal, and mechanical properties. Having superior properties and light weight, CNTs have a wide range of applications including in the aerospace industry.

### SUMMARY

A humidity protection shield assembly for a carbon nanotube (CNT) fabric composite heater assembly is disclosed herein. The humidity protection shield assembly includes a first portion, a second portion, and the CNT fabric composite heater assembly disposed between the first portion and the second portion. The first portion includes at least one of one or more first di-electric layers or one or more first thermoplastic/thermoplastic composite di-electric layers, at least one of a first carbon fiber layer or a first composite carbon fiber layer, and at least one of a first metal humidity layer or a first metalized film humidity layer. The second portion includes at least one of one or more second di-electric layers or one or more second thermoplastic/thermoplastic composite di-electric layers, at least one of a second carbon fiber layer or a second composite carbon fiber layer, and at least one of a second metal humidity layer or a second metalized film humidity layer.

In various embodiments, the first portion includes a first side of the one or more first di-electric layers coupled to a first side of the CNT fabric composite heater assembly, a first side of the first carbon fiber composite layer coupled to a second side of the one or more first di-electric layers, and a first side of the first metal humidity layer coupled to a second side of the first carbon fiber composite layer. In various embodiments, the second portion includes a first side of the one or more second di-electric layers coupled to a second side of the CNT fabric composite heater assembly, a first side of the second carbon fiber composite layer coupled to a second side of the one or more second di-electric layers, and a first side of the second metal humidity layer coupled to a second side of the second carbon fiber composite layer.

In various embodiments, the first portion includes a first side of the one or more first thermoplastic/thermoplastic composite di-electric layers coupled to a first side of the CNT fabric composite heater assembly, a first side of the first thermoplastic composite carbon fiber layer coupled to a second side of the one or more first thermoplastic/thermoplastic composite di-electric layers, and a first side of the first metal humidity layer coupled to a second side of the first thermoplastic composite carbon fiber layer. In various embodiments, the second portion includes a first side of the one or more second thermoplastic/thermoplastic composite di-electric layers may be coupled to a second side of the CNT fabric composite heater assembly, a first side of the second thermoplastic composite carbon fiber layer coupled to a second side of the one or more second thermoplastic/thermoplastic composite di-electric layers, and a first side of the second metalized film humidity layer may be coupled to a second side of the second thermoplastic composite carbon fiber layer.

In various embodiments, the first portion includes a first side of the one or more first thermoplastic/thermoplastic composite di-electric layers coupled to a first side of the CNT fabric composite heater assembly, a first side of the first carbon fiber composite layer coupled to a second side of the one or more first thermoplastic/thermoplastic composite di-electric layers, and a first side of the first metalized film humidity layer coupled to a second side of the first carbon fiber composite layer. In various embodiments, the second portion includes a first side of the one or more second thermoplastic/thermoplastic composite di-electric layers coupled to a second side of the CNT fabric composite heater assembly, a first side of the second carbon fiber composite layer coupled to a second side of the one or more second thermoplastic/thermoplastic composite di-electric layers, and a first side of the second metalized film humidity layer coupled to a second side of the second carbon fiber composite layer.

In various embodiments, the first portion includes a first side of the one or more first thermoplastic/thermoplastic composite di-electric layers coupled to a first side of the CNT fabric composite heater assembly, a first side of the first metalized film humidity layer coupled to a second side of the one or more first thermoplastic/thermoplastic composite di-electric layers, and a first side of the first carbon fiber composite layer coupled to a second side of the first metalized film humidity layer. In various embodiments, the second portion includes a first side of the one or more second thermoplastic/thermoplastic composite di-electric layers coupled to a second side of the CNT fabric composite heater assembly, a first side of the second metalized film humidity layer coupled to a second side of the one or more second thermoplastic/thermoplastic composite di-electric layers, and a first side of the second carbon fiber composite layer coupled to a second side of the second metalized film humidity layer.

In various embodiments, the first portion includes a first side of the first metalized film humidity layer coupled to a first side of the CNT fabric composite heater assembly, a first side of the one or more first thermoplastic/thermoplastic composite di-electric layers coupled to a second side of the first metalized film humidity layer, and a first side of the first carbon fiber composite layer coupled to the second side of the one or more first thermoplastic/thermoplastic composite di-electric layers. In various embodiments, the second portion includes a first side of the second metalized film humidity layer coupled to a second side of the CNT fabric composite heater assembly, a first side of the one or more second thermoplastic/thermoplastic composite di-electric layers to a second side of the second metalized film humidity layer, and a first side of the second carbon fiber composite layer coupled to the second side of the one or more second thermoplastic/thermoplastic composite di-electric layers.

In various embodiments, the first portion includes a first side of the one or more first thermoplastic/thermoplastic composite di-electric layers coupled to a first side of the CNT fabric composite heater assembly, a first side of the first metalized film humidity layer coupled to a second side of the one or more first thermoplastic/thermoplastic composite di-electric layers, and a first side of the first carbon fiber composite layer coupled to the second side of the first metalized film humidity layer. In various embodiments, the second portion includes a first side of the one or more second thermoplastic/thermoplastic composite di-electric layers coupled to a second side of the CNT fabric composite heater assembly, a first side of the second carbon fiber composite layer coupled to a second side of the one or more second thermoplastic/thermoplastic composite di-electric layers, and a first side of the second metalized film humidity layer coupled to a second side of the second carbon fiber composite layer.

In various embodiments, the first portion includes a first side of the first metalized film humidity layer coupled to a first side of the CNT fabric composite heater assembly, a first side of the one or more first thermoplastic/thermoplastic composite di-electric layers coupled to a second side of the first metalized film humidity layer, and a first side of the first carbon fiber composite layer coupled to a second side of the one or more first thermoplastic/thermoplastic composite di-electric layers. In various embodiments, the second portion includes a first side of the one or more second thermoplastic/thermoplastic composite di-electric layers coupled to a second side of the CNT fabric composite heater assembly, a first side of the second carbon fiber composite layer coupled to a second side of the one or more second thermoplastic/thermoplastic composite di-electric layers, and a first side of the second metalized film humidity layer coupled to a second side of the second carbon fiber composite layer.

In various embodiments, the first metal humidity layer and the second metal humidity layer are each comprised of at least one of titanium, stainless steel, nickel, or aluminum.

In various embodiments, the first metalized film humidity layer and the second metalized film humidity layer are each comprised of a layer of polymeric plastic coated with a metal. In various embodiments, the metal is at least one of a layer titanium, stainless steel, nickel, or aluminum.

In various embodiments, responsive to the first metalized film humidity layer being coupled to at least one of the first side of the CNT fabric composite heater assembly or the first thermoplastic composite carbon fiber layer, a metal side of the first metalized film humidity layer is faced away from the at least one of the first side of the CNT fabric composite heater assembly or the first thermoplastic composite carbon fiber layer.

In various embodiments, responsive to the second metalized film humidity layer being coupled to at least one of the second side of the CNT fabric composite heater assembly or the second thermoplastic composite carbon fiber layer, a metal side of the second metalized film humidity layer is faced away from the at least one of the second side of the CNT fabric composite heater assembly or the second thermoplastic composite carbon fiber layer.

Also disclosed herein is a humidity protection shield assembly for a CNT fabric composite heater assembly. The humidity protection shield assembly includes a first portion, a second portion, and the CNT fabric composite heater assembly disposed between the first portion and the second portion. The first portion includes a first side of one or more first di-electric layers coupled to a first side of the CNT fabric composite heater assembly and a first side of a metallic leading edge/skin coupled to a second side of the one or more first di-electric layers. The second portion includes one of one or more second di-electric layers and at least one of a metal humidity layer or a metalized film humidity layer.

In various embodiments, the second portion includes a first side of the one or more second di-electric layers coupled to a second side of the CNT fabric composite heater assembly and a first side of the metal humidity layer coupled to a second side of the one or more second di-electric layers.

In various embodiments, the second portion includes a first side of the metal humidity layer coupled to second side of the CNT fabric composite heater assembly and a first side of the one or more second di-electric layers coupled to a second side of the metal humidity layer.

In various embodiments, the second portion includes a first side of the one or more second di-electric layers coupled to a second side of the CNT fabric composite heater assembly and a first side of the metalized film humidity layer coupled to a second side of the one or more second di-electric layers.

In various embodiments, the second portion includes a first side of the metalized film humidity layer coupled to second side of the CNT fabric composite heater assembly and a first side of the one or more second di-electric layers coupled to a second side of the metalized film humidity layer.

In various embodiments, the metal humidity layer is comprised of at least one of titanium, stainless steel, nickel, or aluminum.

In various embodiments, the metalized film humidity layer is comprised of a layer of polymeric plastic coated with a metal. In various embodiments, the metal is at least one of a layer titanium, stainless steel, nickel, or aluminum.

In various embodiments, responsive to the metalized film humidity layer being coupled to the second side of the CNT fabric composite heater assembly, a metal side of the metalized film humidity layer is faced away from the second side of the CNT fabric composite heater assembly.

The foregoing features and elements may be combined in any combination, without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates an aircraft including a deicing assembly on the wings, in accordance with various embodiments.

FIG. 2 illustrates a cross sectional view of a resistive heating system with a CNT consolidated in silicon rubber, in accordance with various embodiments.

FIG. 3 illustrates a cross-sectional view of CNT fabric composite heater assembly with the humidity protection shield, in accordance with various embodiments.

FIG. 4 illustrates a cross-sectional view of CNT fabric composite heater assembly with the humidity protection shield, in accordance with various embodiments.

FIG. 5 illustrates a cross-sectional view of CNT fabric composite heater assembly with the humidity protection shield, in accordance with various embodiments.

FIG. 6 illustrates a cross-sectional view of CNT fabric composite heater assembly with the humidity protection shield, in accordance with various embodiments.

FIG. 7 illustrates a cross-sectional view of CNT fabric composite heater assembly with the humidity protection shield, in accordance with various embodiments.

FIG. 8 illustrates a cross-sectional view of CNT fabric composite heater assembly with the humidity protection shield, in accordance with various embodiments.

FIG. 9 illustrates a cross-sectional view of CNT fabric composite heater assembly with the humidity protection shield, in accordance with various embodiments.

FIG. 10 illustrates a cross-sectional view of CNT fabric composite heater assembly with the humidity protection shield, in accordance with various embodiments.

FIG. 11 illustrates a cross-sectional view of CNT fabric composite heater assembly with the humidity protection shield, in accordance with various embodiments.

FIG. 12 illustrates a cross-sectional view of CNT fabric composite heater assembly with the humidity protection shield, in accordance with various embodiments.

FIG. 13 illustrates a cross-sectional view of CNT fabric composite heater assembly with the humidity protection shield, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. While these exemplary embodiments are described in sufficient detail to enable those skilled in the art to practice the invention, it should be understood that other embodiments may be realized and that logical, chemical, and mechanical changes may be made without departing from the spirit and scope of the invention. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an,” or “the” may include one or more than one and that reference to an item in the singular may also include the item in the plural. Further, all ranges may include upper and lower values and all ranges and ratio limits disclosed herein may be combined.

As discussed previously, carbon nanotubes (CNT) are cylindrical nanostructures composed of carbon atoms. A CNT sheet is a material formed by depositing CNT on a flat sheet or on a drum and then unrolling the CNT. Being an allotrope of carbon, CNTs exhibit excellent electrical, thermal, and mechanical properties. Having superior properties and being light weight, i.e., low density, CNTs have a wide range of applications including in the aerospace industry. CNT fabric may be impregnated with resin to form a CNT composite heater and integrated into an airfoil for electrothermal ice protection. However, CNT fabric may be susceptible to environmental humidity, resulting in considerable electrical resistance shift over time or under long term power cycles. Accordingly, protecting CNT fabric from absorbing environmental humidity for stable resistance may be achieved by incorporating a thorough resin impregnation and additional humidity shield plies, as discussed hereafter.

Disclosed herein is a carbon nanotube (CNT) fabric composite heater assembly for ice protection with integrated humidity protection shield. In various embodiments, the CNT fabric composite heater assembly includes a CNT sheet that is embedded in a first layer of precured thermoset resin or thermoplastic, i.e. a precured thermoset resin such as epoxy or thermoplastic resin such as polyetheretherketone (PEEK) or low-melt PEEK, i.e. polyaryletherketone (PAEK), polypropylene (PP), polyethylene (PE), or polyvinyl chloride (PVC), among others. Once embedded, in various embodiments, conductive wire leads are secured to both ends of the CNT sheet. In various embodiments, the conductive wire leads are secured to both ends of the CNT sheet via a coupling device, such as a butt splice, spade connection, or crimp connection, among others. In various embodiments, the conductive wire leads are then partially embedded within the first layer of precured thermoset resin or thermoplastic, with the conductive wire leads exiting the first layer of precured thermoset resin or thermoplastic for connection to a controller and/or power source controlled by a controller. In various embodiments, a second layer of precured thermoset resin or thermoplastic is then coupled to the first layer of precured thermoset resin or thermoplastic such that the CNT sheet and a portion of the conductive wire leads are sandwiched between the first layer of precured thermoset resin or thermoplastic and the second layer of precured thermoset resin or thermoplastic. In various embodiments, the first layer and the second layer are heated with the CNT sheet disposed there between to infuse through the CNT sheet into the first layer and the second layer or to bond the first layer and the second layer together to encapsulate CNT thereby forming the CNT fabric composite heater assembly.

In various embodiments, the CNT fabric composite heater assembly may then be positioned within a humidity protection shield assembly. In various embodiments, the humidity protection shield assembly includes a first portion on a leading edge or breeze side and a second portion on aerostructure or back side. In various embodiments, the CNT fabric composite heater assembly may be positioned between the first portion and the second portion. In various embodiments, the first portion may have a same composition as the second portion. In various embodiments, the second portion may have a different composition than the second portion. In various embodiments, both the first portion and the second portion may include either a di-electric layer or a thermoplastic/thermoplastic composite di-electric layer, either a carbon fiber layer or a composite carbon fiber layer, and either a metal humidity layer or a metalized film humidity layer. In various embodiments, the metalized film humidity layer includes a plastic portion with a metal coating on one side. In various embodiments, the first portion may include either a di-electric layer and a metal skin layer. In various embodiments, the second side may include a di-electric layer and either a metal humidity layer or a metalized film humidity layer. Again, in various embodiments, the metalized film humidity layer includes a plastic portion with a metal coating on one side. In various embodiments, the CNT fabric composite heater assembly positioned within the humidity protection shield assembly may then be cured. Once cured, the CNT fabric composite heater assembly with the humidity protection shield may then be coupled to the particular area of the aircraft for which the resistive heating system is designed. In various embodiments, the conductive wire leads are then coupled to a controller and/or power source controlled by a controller and operated by the controller.

As stated previously, the CNT fabric composite heater assembly with the humidity protection shield may be utilized in supercapacitors, flexible electronics, energy storage devices, artificial muscles, aircraft structures, such as deicing systems, environmental warming, as well as other aircraft heating systems, portable water systems (PWS), and vacuum waste systems (VWS). While the following is directed to deicing systems, the illustrative embodiments are not limited to only these applications. In that regard the deicing application described below are only utilized as one example.

Typically, an aircraft is pushed through the air to generate lift. Aircraft wings may generate most of the lift associated with holding the aircraft in the air. Accordingly, aircraft wings may be shaped as an airfoil. An airfoil may be a cross-sectional shape of an object whose motion through a fluid is capable of generating lift. The air may resist aircraft motion in the form of aerodynamic drag. Turbine engines may provide thrust to overcome drag and push the aircraft forward. A wing's aerodynamic efficiency may be expressed as a lift-to-drag ratio. A high lift-to-drag ratio may be associated with a smaller thrust to propel the wings through the air at sufficient lift, and vice versa.

Ice formation on a leading edge of a wing, as well as other aircraft structures, such as vertical stabilizers or horizontal stabilizers, nacelles, rotary blades, or aircraft domes, among others, may disrupt or destroy the smooth flow of air along the aircraft structures, increasing drag while decreasing the ability of the wing to create lift. Accordingly, ice formation on the leading edge of an aircraft structures may prevent an aircraft from taking off, or worse, may interfere with flight.

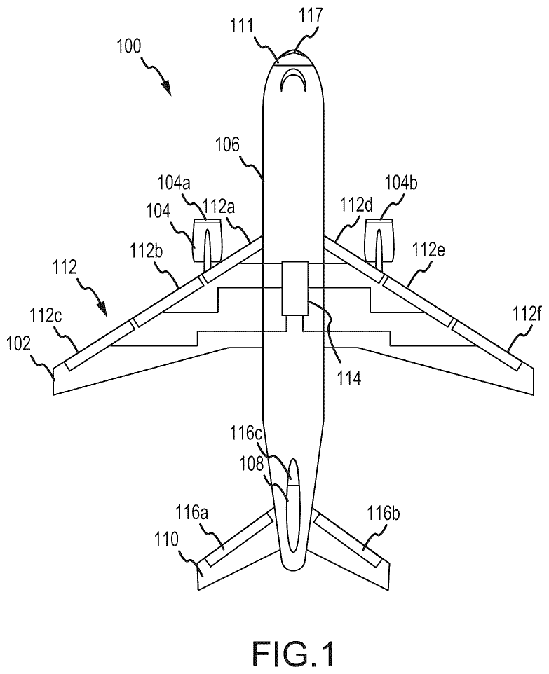

Referring now to FIG. 1, a top view of an aircraft 100 is illustrated, in accordance with various embodiments. Aircraft 100 includes wings 102, nacelles 104 around engines, a fuselage 106, a vertical stabilizer 108, horizontal stabilizers 110, and dome 111, among other control surfaces. Aircraft 100 further includes a plurality of de-icing assemblies 112 including de-icing assemblies 112a, 112b, 112c on a first wing 102, de-icing assemblies 112d, 112e, 112f on a second wing 102, de-icing assemblies 104a and 104b on nacelles 104, de-icing assemblies 116c on vertical stabilizer 108, de-icing assemblies 116a and 116b on horizontal stabilizers 110, and de-icing assembly 117 on dome 111. In various embodiments, de-icing assemblies 112a-f may be located on a leading edge of each wing 102 (as illustrated in FIG. 1), de-icing assemblies 104a and 104b may be located on engine inlets of each engine 104, de-icing assemblies 116c may be located on a leading edge of vertical stabilizer 108, de-icing assemblies 116a and 116b may be located on a leading edge of horizontal stabilizers 110, and de-icing assembly 117 may be located on a leading edge of dome 111 to prevent the buildup of ice on the leading edges. In various embodiments, de-icing assemblies 112a, 112d may be located at a proximal end of wings 102 adjacent the fuselage 106, de-icing assemblies 112c, 112f may be located at a distal end of wings 102, and de-icing assemblies 112b, 112e may be located between de-icing assemblies 112a, 112d and de-icing assemblies 112c, 112f, respectively.

In various embodiments, de-icing assemblies 112 may be located on an external surface of wings 102, de-icing assemblies 104a and 104b may be located on an external surface of engine inlets of each engine 104, de-icing assemblies 116c may be located on an external surface of vertical stabilizer 108, de-icing assemblies 116a and 116b may be located on an external surface of horizontal stabilizers 110, de-icing assembly 117 may be located on an external surface of dome 111. For simplicity and ease of discussion, de-icing assemblies 112 will be described hereafter as being coupled to the leading edge of wings 102, though other locations are considered.

In various embodiments, each of the de-icing assemblies 112a-112f may be individually coupled to a controller 114. In various embodiments, controller 114 may comprise one or more processors configured to implement various logical operations in response to execution of instructions, for example, instructions stored on a non-transitory, tangible, computer-readable medium. The one or more processors can be a general-purpose processor, a microprocessor, a microcontroller, a digital signal processor (DSP), an application specific integrated circuit (ASIC), a field programmable gate array (FPGA) or other programmable logic device, discrete or transistor logic, discrete hardware components, or any combination thereof. In various embodiments, controller 114 may further comprise memory to store data, executable instructions, system program instructions, and/or controller instructions to implement the control logic of controller 114.

System program instructions and/or controller instructions may be loaded onto a non-transitory, tangible computer-readable medium having instructions stored thereon that, in response to execution by the controller 114, cause the controller 114 to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

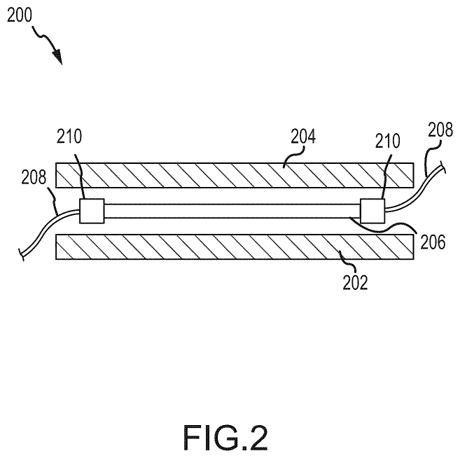

Referring to FIG. 2, in accordance with various embodiments, a cross sectional view of a resistive heating system with a carbon nanotube consolidated in resin, is illustrated. In various embodiments, the CNT fabric composite heater assembly 200 includes a first sheet 202 and a second sheet 204. In various embodiments, the first sheet 202 and the second sheet 204 may be precured thermoset resin or thermoplastic, among others. In various embodiments, the first sheet 202 and the second sheet 204 may both be reinforced with fiberglass. In various embodiments, a CNT sheet 206 is embedded in a first side of the first sheet 202. In various embodiments, the CNT sheet 206 may be routed in a desired pattern on the first side of the first sheet 202. Once embedded, in various embodiments, conductive wire leads 208 are secured to both ends of the CNT sheet 206. In various embodiments, the conductive wire leads 208 are secured to both ends of the CNT sheet 206 via a coupling device 210, such as a butt splice, spade connection, or crimp connection, among others. In various embodiments, the conductive wire leads 208 are then partially embedded within the first side of the first sheet 202, with the conductive wire leads 208 exiting the first sheet for connection to a controller and/or power source controlled by a controller. In various embodiments, a first side of a second sheet 204 is then coupled to the first side of the first sheet 202 such that the CNT sheet 206 and a portion of the conductive wire leads 208 and/or the coupling device 210 are sandwiched between the first sheet 202 and the second sheet 204. The first sheet 202 and the second sheet 204 may then be melted to infuse through the CNT sheet 206 or to bond the first sheet 202 and the second sheet 204 together to encapsulate CNT sheet 206.

In various embodiments, the CNT fabric composite heater assembly 200 may then be positioned within a humidity protection shield assembly, which is described hereafter. In various embodiments, the CNT fabric composite heater assembly 200 with the humidity protection shield is then cured. In various embodiments, the curing may be via vulcanization. In various embodiments, the curing may be via crosslinking. In that regard, the CNT fabric composite heater assembly 200 with the humidity protection shield may be positioned in an autoclave to be cured. The curing may be performed at a predetermined pressure, under a predetermined vacuum, at a predetermined temperature, for a predetermined time. In various embodiments, the predetermined pressure may be between 3.2 bars and 4.2 bars. In various embodiments, the predetermined pressure may be between 3.5 bars and 3.9 bars. In various embodiments, the predetermined pressure may be 3.7 bars. In various embodiments, the predetermined vacuum may be between 80 KPa and 90 KPa. In various embodiments, the predetermined vacuum may be between 83 KPa and 87 KPa. In various embodiments, the predetermined vacuum may be 85 KPa. In various embodiments, the predetermined temperature may be between 284° F. (140° C.) and 320° F. (160° C.). In various embodiments, the predetermined temperature may be between 293° F. (145° C.) and 311° F. (155° C.). In various embodiments, the predetermined temperature may be 302° F. (150° C.). In various embodiments, the predetermined time may be between 2 hours and 3 hours. In various embodiments, the predetermined time may be between 2.25 hours and 2.75 hours. In various embodiments, the predetermined time may be 2.5 hours. Once cured, CNT fabric composite heater assembly 200 with the humidity protection shield may then be coupled to the particular area of the aircraft for which the CNT fabric composite heater assembly 200 with the humidity protection shield is designed. In various embodiments, the conductive wire leads 208 are then coupled to a controller and/or power source controlled by a controller and operated by the controller. The CNT fabric composite heater may also be placed in a heated press with pressures between 60 pounds per square inch gauge (psig) and 500 psig and temperature between 200° F. and 900° F.

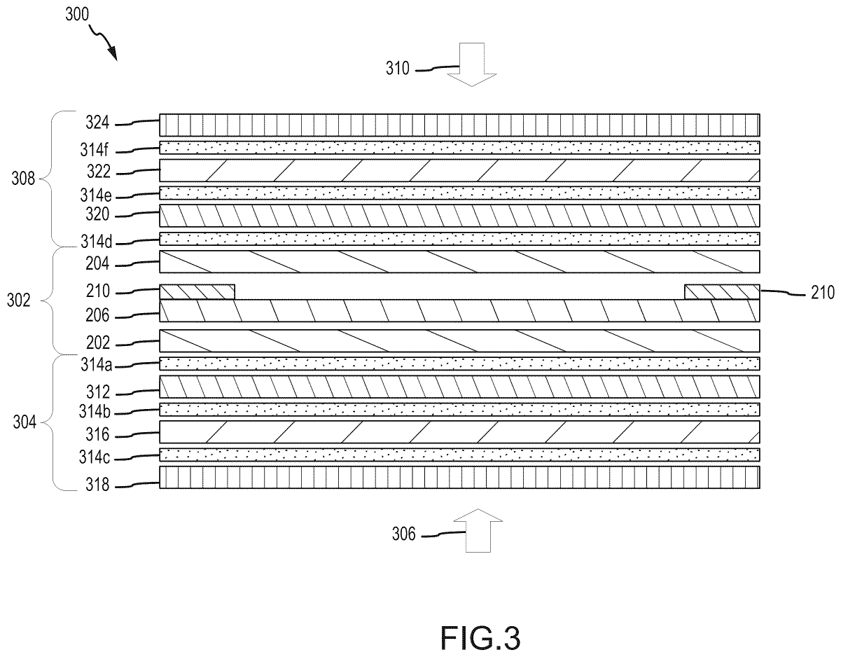

Referring to FIG. 3, in accordance with various embodiments, a cross-sectional view of CNT fabric composite heater assembly with the humidity protection shield, is illustrated. In various embodiments, the CNT fabric composite heater assembly with the humidity protection shield 300 includes CNT fabric composite heater assembly 302 that is similar to the CNT fabric composite heater assembly 200 of FIG. 2. In that regard, in various embodiments, a CNT sheet 206 is embedded in a first side of the first sheet 202. In various embodiments, the CNT sheet 206 may be routed in a desired pattern on the first side of the first sheet 202. Once embedded, in various embodiments, conductive wire leads are secured to both ends of the CNT sheet 206 via a coupling device 210. In various embodiments, the first side of the second sheet 204 is then coupled to the first side of the first sheet 202 such that the CNT sheet 206 and a portion of the conductive wire leads and/or the coupling device 210 are sandwiched between the first sheet 202 and the second sheet 204.

In various embodiments, the CNT fabric composite heater assembly 302 may be positioned within a humidity protection shield assembly. In various embodiments, the humidity protection shield assembly includes a first portion 304 on a leading edge or breeze side 306 and a second portion 308 on aerostructure or back side 310. In that regard, in various embodiments, the CNT fabric composite heater assembly 302 may be positioned between the first portion 304 and the second portion 308. In various embodiments, a first side of one or more first di-electric layers 312 may be coupled to a second side of the first sheet 202. In various embodiments, the first side of the one or more first di-electric layers 312 may be coupled to the second side of the first sheet 202 via a first adhesive layer 314a. In various embodiments, a first side of a first carbon fiber composite layer 316 may be coupled to a second side of the one or more first di-electric layers 312. In various embodiments, the first side of the first carbon fiber composite layer 316 may be coupled to the second side of the one or more first di-electric layers 312 via a second adhesive layer 314b. In various embodiments, a first side of a first metal humidity layer 318 may be coupled to a second side of the first carbon fiber composite layer 316. In various embodiments, the first metal humidity layer 318 may be comprised of one or more of titanium, stainless steel, nickel, or aluminum, among others, i.e., corrosion resistive materials. In various embodiments, the first side of the first metal humidity layer 318 may be coupled to the second side of the first carbon fiber composite layer 316 via a third adhesive layer 314c.

In various embodiments, a first side of one or more second di-electric layers 320 may be coupled to a second side of the second sheet 204. In various embodiments, the first side of the one or more second di-electric layers 320 may be coupled to the second side of the second sheet 204 via a fourth adhesive layer 314d. In various embodiments, a first side of a second carbon fiber composite layer 322 may be coupled to a second side of the one or more second di-electric layers 320. In various embodiments, the first side of the second carbon fiber composite layer 322 may be coupled to the second side of the one or more second di-electric layers 320 via a fifth adhesive layer 314e. In various embodiments, a first side of a second metal humidity layer 324 may be coupled to a second side of the second carbon fiber composite layer 322. In various embodiments, the second metal humidity layer 324 may be comprised of one or more of titanium, stainless steel, nickel, or aluminum, among others, i.e., corrosion resistive materials. In various embodiments, the first side of the second metal humidity layer 324 may be coupled to the second side of the second carbon fiber composite layer 322 via a sixth adhesive layer 314f. In various embodiments, the first adhesive layer 314a, the second adhesive layer 314b, the third adhesive layer 314c, the fourth adhesive layer 314d, the fifth adhesive layer 314e, and the sixth adhesive layer 314f may be an epoxy-based adhesive.

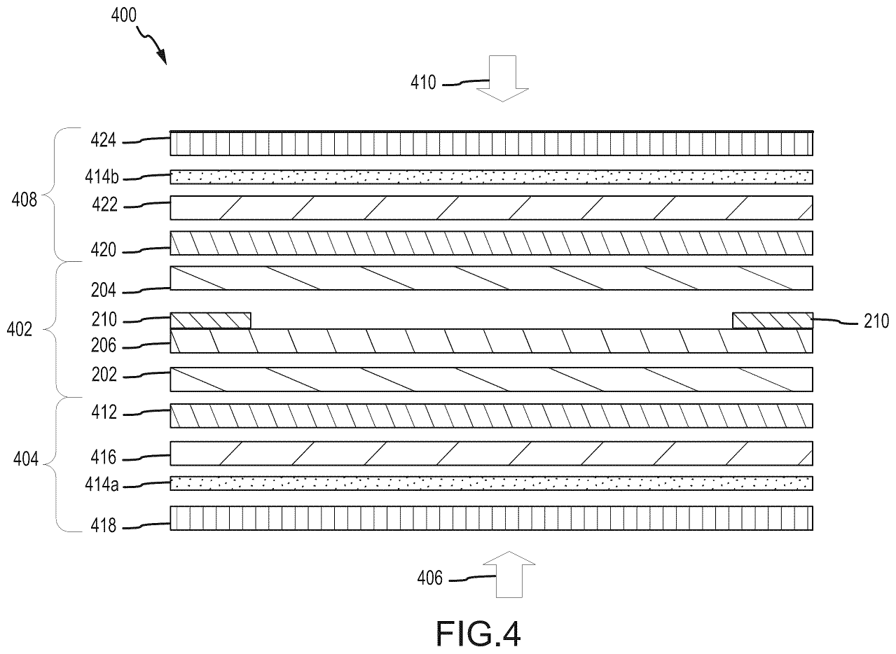

Referring to FIG. 4, in accordance with various embodiments, a cross-sectional view of CNT fabric composite heater assembly with the humidity protection shield, is illustrated. In various embodiments, the CNT fabric composite heater assembly with the humidity protection shield 400 includes CNT fabric composite heater assembly 402 that is similar to the CNT fabric composite heater assembly 200 of FIG. 2. In that regard, in various embodiments, a CNT sheet 206 is embedded in a first side of the first sheet 202. In various embodiments, the CNT sheet 206 may be routed in a desired pattern on the first side of the first sheet 202. Once embedded, in various embodiments, conductive wire leads are secured to both ends of the CNT sheet 206 via a coupling device 210. In various embodiments, the first side of the second sheet 204 is then coupled to the first side of the first sheet 202 such that the CNT sheet 206 and a portion of the conductive wire leads and/or the coupling device 210 are sandwiched between the first sheet 202 and the second sheet 204.

In various embodiments, the CNT fabric composite heater assembly 402 may be positioned within a humidity protection shield assembly. In various embodiments, the humidity protection shield assembly includes a first portion 404 on a leading edge or breeze side 406 and a second portion 408 on aerostructure or back side 410. In that regard, in various embodiments, the CNT fabric composite heater assembly 402 may be positioned between the first portion 404 and the second portion 408. In various embodiments, a first side of one or more first thermoplastic/thermoplastic composite di-electric layers 412 may be coupled to a second side of the first sheet 202. In various embodiments, no adhesive is used between the first side of the one or more first thermoplastic/thermoplastic composite di-electric layers 412 and the second side of the first sheet 202 because the first side of the one or more first thermoplastic/thermoplastic composite di-electric layers 412 may melt, during processing, and couple to the second side of the first sheet 202. In various embodiments, a first side of a first composite carbon fiber layer 416 may be coupled to a second side of the one or more first thermoplastic/thermoplastic composite di-electric layers 412. In various embodiments, no adhesive is used between the first side of the first composite carbon fiber layer 416 and the second side of the one or more first thermoplastic/thermoplastic composite di-electric layers 412 because the first side of the first composite carbon fiber layer 416 may melt, during processing, and couple to the second side of the one or more first thermoplastic/thermoplastic composite di-electric layers 412. In various embodiments, a first side of a first metal humidity layer 418 may be coupled to a second side of the first composite carbon fiber layer 416. In various embodiments, the first metal humidity layer 418 may be comprised of one or more of titanium, stainless steel, nickel, or aluminum, among others, i.e., corrosion resistive materials. In various embodiments, the first side of the first metal humidity layer 418 may be coupled to the second side of the first composite carbon fiber layer 416 via a first adhesive layer 414a.

In various embodiments, a first side of one or more second thermoplastic/thermoplastic composite di-electric thermoplastic/thermoplastic composite di-electric layers 420 may be coupled to a second side of the second sheet 204. In various embodiments, no adhesive is used between the first side of the one or more second thermoplastic/thermoplastic composite di-electric thermoplastic/thermoplastic composite di-electric layers 420 and the second side of the second sheet 204 because the first side of the one or more second thermoplastic/thermoplastic composite di-electric layers 420 may melt, during processing, and couple to the second side of the second sheet 204. In various embodiments, a first side of a second composite carbon fiber layer 422 may be coupled to a second side of the one or more second thermoplastic/thermoplastic composite di-electric thermoplastic/thermoplastic composite di-electric layers 420. In various embodiments, no adhesive is used between the first side of the second composite carbon fiber layer 422 and the second side of the one or more second thermoplastic/thermoplastic composite di-electric layers 420 because the first side of the second composite carbon fiber layer 422 may melt, during processing, and couple to the second side of the one or more second thermoplastic/thermoplastic composite di-electric layers 420. In various embodiments, a first side of a second metalized film humidity layer 424 may be coupled to a second side of the second composite carbon fiber layer 422. In various embodiments, the second metalized film humidity layer 424 may be comprised of a layer of polymeric plastic coated with a layer of one or more of titanium, stainless steel, nickel, or aluminum, among others, i.e., corrosion resistive materials. In various embodiments, the metal portion of the second metalized film humidity layer 424 is faced away from the second composite carbon fiber layer 422 to prevent corrosion. In various embodiments, the first side, i.e., the plastic side, of the second metalized film humidity layer 424 may be coupled to the second side of the second composite carbon fiber layer 422 via a second adhesive layer 414b. In various embodiments, the first adhesive layer 414a and the second adhesive layer 414b may be an epoxy-based adhesive.

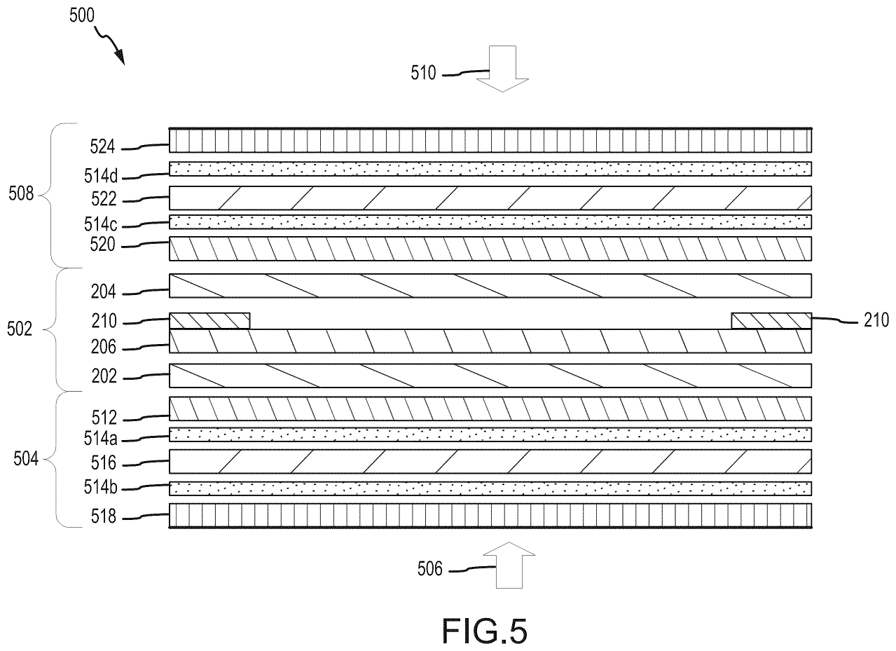

Referring to FIG. 5, in accordance with various embodiments, a cross-sectional view of CNT fabric composite heater assembly with the humidity protection shield, is illustrated. In various embodiments, the CNT fabric composite heater assembly with the humidity protection shield 500 includes CNT fabric composite heater assembly 502 that is similar to the CNT fabric composite heater assembly 200 of FIG. 2. In that regard, in various embodiments, a CNT sheet 206 is embedded in a first side of the first sheet 202. In various embodiments, the CNT sheet 206 may be routed in a desired pattern on the first side of the first sheet 202. Once embedded, in various embodiments, conductive wire leads are secured to both ends of the CNT yarn 206 via a coupling device 210. In various embodiments, the first side of the second sheet 204 is then coupled to the first side of the first sheet 202 such that the CNT sheet 206 and a portion of the conductive wire leads and/or the coupling device 210 are sandwiched between the first sheet 202 and the second sheet 204.

In various embodiments, the CNT fabric composite heater assembly 502 may be positioned within a humidity protection shield assembly. In various embodiments, the humidity protection shield assembly includes a first portion 504 on a leading edge or breeze side 506 and a second portion 508 on aerostructure or back side 510. In that regard, in various embodiments, the CNT fabric composite heater assembly 502 may be positioned between the first portion 504 and the second portion 508. In various embodiments, a first side of one or more first thermoplastic/thermoplastic composite di-electric layers 512 may be coupled to a second side of the first sheet 202. In various embodiments, no adhesive is used between the first side of the one or more first thermoplastic/thermoplastic composite di-electric layers 512 and the second side of the first sheet 202 because the first side of the one or more first thermoplastic/thermoplastic composite di-electric layers 512 may melt, during processing, and couple to the second side of the first sheet 202. In various embodiments, a first side of a first carbon fiber composite layer 516 may be coupled to a second side of the one or more first thermoplastic/thermoplastic composite di-electric layers 512. In various embodiments, the first side of the first carbon fiber composite layer 516 may be coupled to the second side of the one or more first thermoplastic/thermoplastic composite di-electric layers 512 via a first adhesive layer 514a. In various embodiments, a first side of a first metalized film humidity layer 518 may be coupled to a second side of the first carbon fiber composite layer 516. In various embodiments, the first metalized film humidity layer 518 may be comprised of a layer of polymeric plastic coated with a layer of one or more of titanium, stainless steel, nickel, or aluminum, among others, i.e., corrosion resistive materials. In various embodiments, the metal portion of the first metalized film humidity layer 518 is faced away from the first carbon fiber composite layer 516 to prevent corrosion. In various embodiments, the first side, i.e., the plastic side, of the first metalized film humidity layer 518 may be coupled to the second side of the first carbon fiber composite layer 516 via a second adhesive layer 514b.

In various embodiments, a first side of one or more second thermoplastic/thermoplastic composite di-electric layers 520 may be coupled to a second side of the second sheet 204. In various embodiments, no adhesive is used between the first side of the one or more second thermoplastic/thermoplastic composite di-electric layers 520 and the second side of the second sheet 204 because the first side of the one or more second thermoplastic/thermoplastic composite di-electric layers 520 may melt, during processing, and couple to the second side of the second sheet 204. In various embodiments, a first side of a second carbon fiber composite layer 522 may be coupled to a second side of the one or more second thermoplastic/thermoplastic composite di-electric layers 520. In various embodiments, the first side of the second carbon fiber composite layer 522 may be coupled to the second side of the one or more second thermoplastic/thermoplastic composite di-electric layers 520 via a third adhesive layer 514c. In various embodiments, a first side of a second metalized film humidity layer 524 may be coupled to a second side of the second carbon fiber composite layer 522. In various embodiments, the second metalized film humidity layer 524 may be comprised of a layer of polymeric plastic coated with a layer of one or more of titanium, stainless steel, nickel, or aluminum, among others, i.e., corrosion resistive materials. In various embodiments, the metal portion of the second metalized film humidity layer 524 is faced away from the second carbon fiber composite layer 522 to prevent corrosion. In various embodiments, the first side, i.e., the plastic side, of the second metalized film humidity layer 524 may be coupled to the second side of the second carbon fiber composite layer 522 via a fourth adhesive layer 514d. In various embodiments, the first adhesive layer 514a, the second adhesive layer 514b, the third adhesive layer 514c, and the fourth adhesive layer 514d, may be an epoxy-based adhesive.

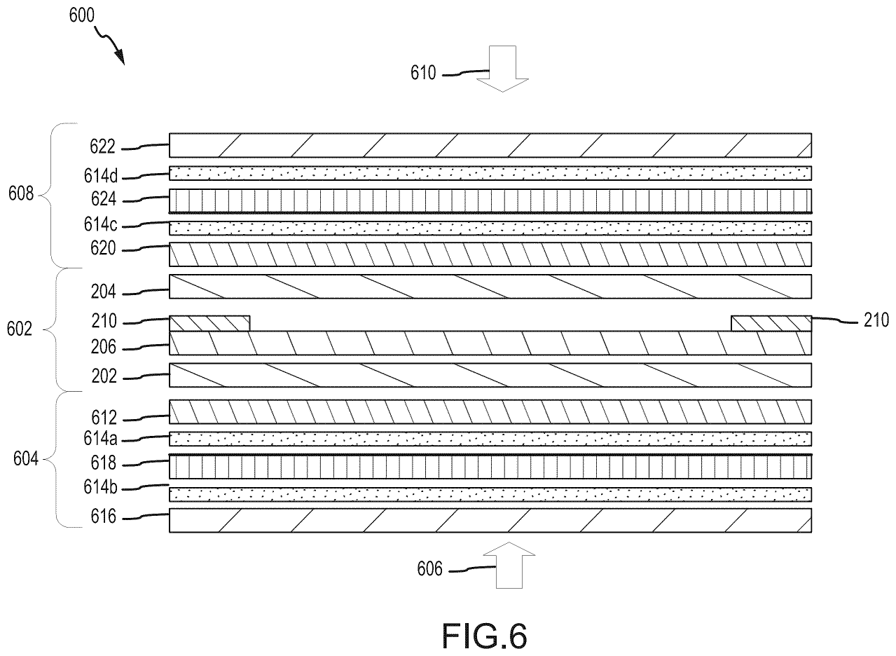

Referring to FIG. 6, in accordance with various embodiments, a cross-sectional view of CNT fabric composite heater assembly with the humidity protection shield, is illustrated. In various embodiments, the CNT fabric composite heater assembly with the humidity protection shield 600 includes CNT fabric composite heater assembly 602 that is similar to the CNT fabric composite heater assembly 200 of FIG. 2. In that regard, in various embodiments, a CNT sheet 206 is embedded in a first side of the first sheet 202. In various embodiments, the CNT sheet 206 may be routed in a desired pattern on the first side of the first sheet 202. Once embedded, in various embodiments, conductive wire leads are secured to both ends of the CNT sheet 206 via a coupling device 210. In various embodiments, the first side of the second sheet 204 is then coupled to the first side of the first sheet 202 such that the CNT sheet 206 and a portion of the conductive wire leads and/or the coupling device 210 are sandwiched between the first sheet 202 and the second sheet 204.

In various embodiments, the CNT fabric composite heater assembly 602 may be positioned within a humidity protection shield assembly. In various embodiments, the humidity protection shield assembly includes a first portion 604 on a leading edge or breeze side 606 and a second portion 608 on aerostructure or back side 610. In that regard, in various embodiments, the CNT fabric composite heater assembly 602 may be positioned between the first portion 604 and the second portion 608. In various embodiments, a first side of one or more first thermoplastic/thermoplastic composite di-electric layers 612 may be coupled to a second side of the first sheet 202. In various embodiments, no adhesive is used between the first side of the one or more first thermoplastic/thermoplastic composite di-electric layers 612 and the second side of the first sheet 202 because the first side of the one or more first thermoplastic/thermoplastic composite di-electric layers 612 may melt, during processing, and couple to the second side of the first sheet 202. In various embodiments, a first side of a first metalized film humidity layer 618 may be coupled to a second side of the one or more first thermoplastic/thermoplastic composite di-electric layers 612. In various embodiments, the first metalized film humidity layer 618 may be comprised of a layer of polymeric plastic coated with a layer of one or more of titanium, stainless steel, nickel, or aluminum, among others, i.e., corrosion resistive materials. In various embodiments, the metal portion of the first metalized film humidity layer 618 is faced away from a first carbon fiber composite layer 616 to prevent corrosion. In various embodiments, the first side, i.e., the metal side, of the first metalized film humidity layer 618 may be coupled to the second side of the one or more first thermoplastic/thermoplastic composite di-electric layers 612 via a first adhesive layer 614a. In various embodiments, a first side of the first carbon fiber composite layer 616 may be coupled to a second side, i.e., the plastic side, of the first metalized film humidity layer 618. In various embodiments, the first side of the first carbon fiber composite layer 616 may be coupled to the second side of the first metalized film humidity layer 618 via a second adhesive layer 614b.

In various embodiments, a first side of one or more second thermoplastic/thermoplastic composite di-electric layers 620 may be coupled to a second side of the second sheet 204. In various embodiments, no adhesive is used between the first side of the one or more second thermoplastic/thermoplastic composite di-electric layers 620 and the second side of the second sheet 204 because the first side of the one or more second thermoplastic/thermoplastic composite di-electric layers 620 may melt, during processing, and couple to the second side of the second sheet 204. In various embodiments, a first side of a second metalized film humidity layer 624 may be coupled to a second side of the one or more second thermoplastic/thermoplastic composite di-electric layers 620. In various embodiments, the second metalized film humidity layer 624 may be comprised of a layer of polymeric plastic coated with a layer of one or more of titanium, stainless steel, nickel, or aluminum, among others, i.e., corrosion resistive materials. In various embodiments, the metal portion of the second metalized film humidity layer 624 is faced away from a second carbon fiber composite layer 622 to prevent corrosion. In various embodiments, the first side, i.e., the metal side, of the second metalized film humidity layer 624 may be coupled to the second side of the one or more second thermoplastic/thermoplastic composite di-electric layers 620 via a third adhesive layer 614c. In various embodiments, a first side of the second carbon fiber composite layer 622 may be coupled to a second side, i.e., the plastic side, of the second metalized film humidity layer 624. In various embodiments, the first side of the second carbon fiber composite layer 622 may be coupled to the second side, i.e., the plastic side, of the second metalized film humidity layer 624 via a fourth adhesive layer 614d. In various embodiments, the first adhesive layer 614a, the second adhesive layer 614b, the third adhesive layer 614c, and the fourth adhesive layer 614d, may be an epoxy-based adhesive.

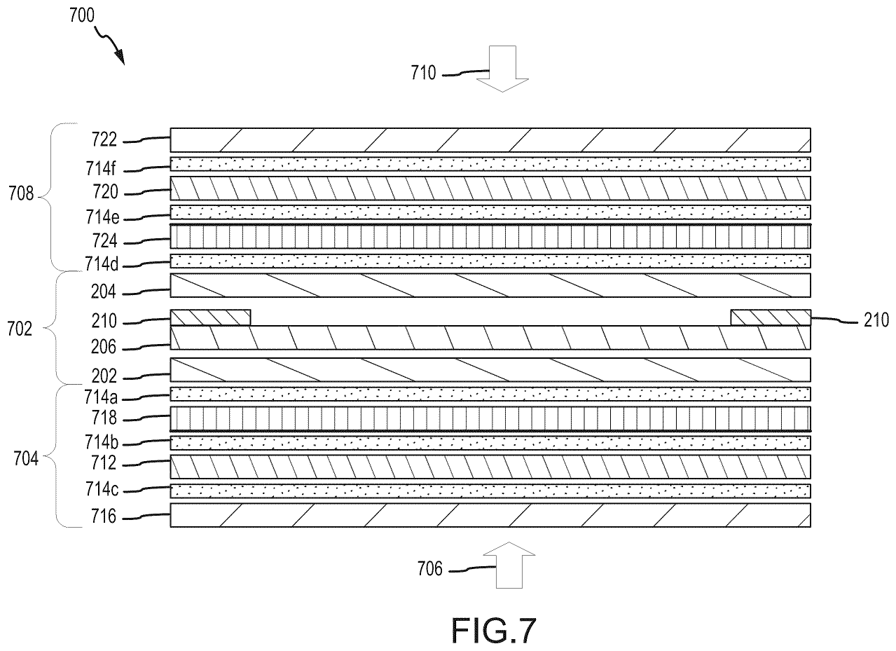

Referring to FIG. 7, in accordance with various embodiments, a cross-sectional view of CNT fabric composite heater assembly with the humidity protection shield, is illustrated. In various embodiments, the CNT fabric composite heater assembly with the humidity protection shield 700 includes CNT fabric composite heater assembly 702 that is similar to the CNT fabric composite heater assembly 200 of FIG. 2. In that regard, in various embodiments, a CNT sheet 206 is embedded in a first side of the first sheet 202. In various embodiments, the CNT sheet 206 may be routed in a desired pattern on the first side of the first sheet 202. Once embedded, in various embodiments, conductive wire leads are secured to both ends of the CNT sheet 206 via a coupling device 210. In various embodiments, the first side of the second sheet 204 is then coupled to the first side of the first sheet 202 such that the CNT sheet 206 and a portion of the conductive wire leads and/or the coupling device 210 are sandwiched between the first sheet 202 and the second sheet 204.

In various embodiments, the CNT fabric composite heater assembly 702 may be positioned within a humidity protection shield assembly. In various embodiments, the humidity protection shield assembly includes a first portion 704 on a leading edge or breeze side 706 and a second portion 708 on aerostructure or back side 710. In that regard, in various embodiments, the CNT fabric composite heater assembly 702 may be positioned between the first portion 704 and the second portion 708. In various embodiments, a first side of a first metalized film humidity layer 718 may be coupled to a second side of the first sheet 202. In various embodiments, the first metalized film humidity layer 718 may be comprised of a layer of polymeric plastic coated with a layer of one or more of titanium, stainless steel, nickel, or aluminum, among others, i.e., corrosion resistive materials. In various embodiments, the metal portion of the first metalized film humidity layer 718 is faced away from the first sheet 202 to prevent corrosion. In various embodiments, the first side, i.e., the plastic side, of the first metalized film humidity layer 718 may be coupled to the second side of the first sheet 202 via a first adhesive layer 714a. In various embodiments, a first side of one or more first thermoplastic/thermoplastic composite di-electric layers 712 may be coupled to a second side, i.e., the metal side, of the first metalized film humidity layer 718. In various embodiments, the first side of the one or more first thermoplastic/thermoplastic composite di-electric layers 712 may be coupled to the second side of the first metalized film humidity layer 718 via a second adhesive layer 714b. In various embodiments, a first side of the first carbon fiber composite layer 716 may be coupled to a second side of the one or more first thermoplastic/thermoplastic composite di-electric layers 712. In various embodiments, the first side of the first carbon fiber composite layer 716 may be coupled to the second side of the one or more first thermoplastic/thermoplastic composite di-electric layers 712 via a third adhesive layer 714c.

In various embodiments, a first side of a second metalized film humidity layer 724 may be coupled to a second side of the second sheet 204. In various embodiments, the second metalized film humidity layer 724 may be comprised of a layer of polymeric plastic coated with a layer of one or more of titanium, stainless steel, nickel, or aluminum, among others, i.e., corrosion resistive materials. In various embodiments, the metal portion of the second metalized film humidity layer 724 is faced away from the second sheet 204 to prevent corrosion. In various embodiments, the first side, i.e., the plastic side, of the second metalized film humidity layer 724 may be coupled to the second side of the second sheet 204 via a fourth adhesive layer 714d. In various embodiments, a first side of one or more second thermoplastic/thermoplastic composite di-electric layers 720 may be coupled to a second side, i.e., the metal side, of the second metalized film humidity layer 724. In various embodiments, the first side of the one or more second thermoplastic/thermoplastic composite di-electric layers 720 may be coupled to the second side of the second metalized film humidity layer 724 via a fifth adhesive layer 714e. In various embodiments, a first side of the second carbon fiber composite layer 722 may be coupled to a second side of the one or more second thermoplastic/thermoplastic composite di-electric layers 720. In various embodiments, the first side of the second carbon fiber composite layer 722 may be coupled to the second side of the one or more second thermoplastic/thermoplastic composite di-electric layers 720 via a sixth adhesive layer 714f. In various embodiments, the first adhesive layer 714a, the second adhesive layer 714b, the third adhesive layer 714c, the fourth adhesive layer 714d, the fifth adhesive layer 714e, the sixth adhesive layer 714f may be an epoxy-based adhesive.

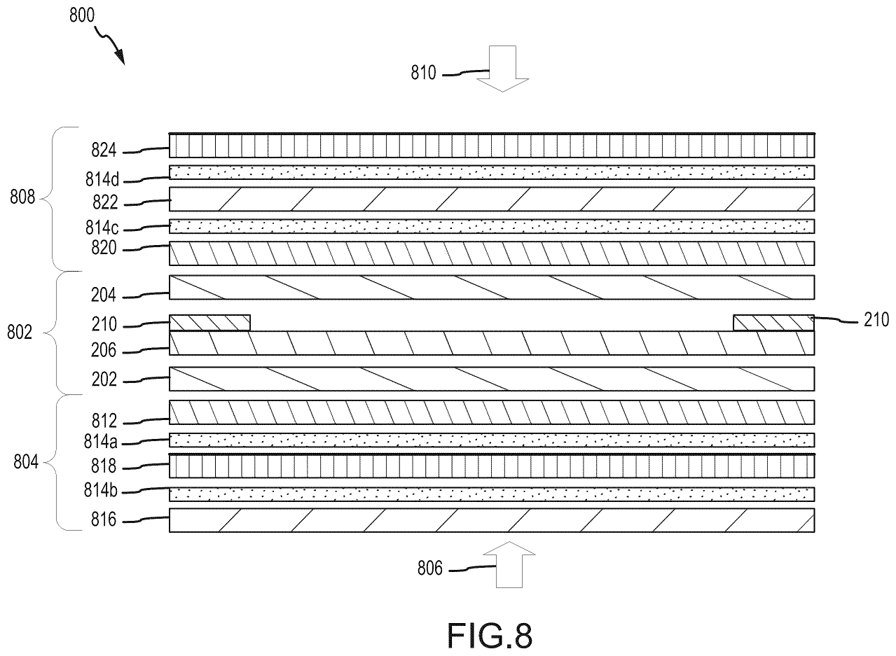

Referring to FIG. 8, in accordance with various embodiments, a cross-sectional view of CNT fabric composite heater assembly with the humidity protection shield, is illustrated. In various embodiments, the CNT fabric composite heater assembly with the humidity protection shield 800 includes CNT fabric composite heater assembly 802 that is similar to the CNT fabric composite heater assembly 200 of FIG. 2. In that regard, in various embodiments, a CNT sheet 206 is embedded in a first side of the first sheet 202. In various embodiments, the CNT sheet 206 may be routed in a desired pattern on the first side of the first sheet 202. Once embedded, in various embodiments, conductive wire leads are secured to both ends of the CNT sheet 206 via a coupling device 210. In various embodiments, the first side of the second sheet 204 is then coupled to the first side of the first sheet 202 such that the CNT sheet 206 and a portion of the conductive wire leads and/or the coupling device 210 are sandwiched between the first sheet 202 and the second sheet 204.

In various embodiments, the CNT fabric composite heater assembly 802 may be positioned within a humidity protection shield assembly. In various embodiments, the humidity protection shield assembly includes a first portion 804 on a leading edge or breeze side 806 and a second portion 808 on aerostructure or back side 810. In that regard, in various embodiments, the CNT fabric composite heater assembly 802 may be positioned between the first portion 804 and the second portion 808. In various embodiments, a first side of one or more first thermoplastic/thermoplastic composite di-electric layers 812 may be coupled to a second side of the first sheet 202. In various embodiments, no adhesive is used between the first side of the one or more first thermoplastic/thermoplastic composite di-electric layers 812 and the second side of the first sheet 202 because the first side of the one or more first thermoplastic/thermoplastic composite di-electric layers 812 may melt, during processing, and couple to the second side of the first sheet 202. In various embodiments, a first side of a first metalized film humidity layer 818 may be coupled to a second side of the one or more first thermoplastic/thermoplastic composite di-electric layers 812. In various embodiments, the first metalized film humidity layer 818 may be comprised of a layer of polymeric plastic coated with a layer of one or more of titanium, stainless steel, nickel, or aluminum, among others, i.e., corrosion resistive materials. In various embodiments, the metal portion of the first metalized film humidity layer 818 is faced away from a first carbon fiber composite layer 816 to prevent corrosion. In various embodiments, the first side, i.e., the metal side, of the first metalized film humidity layer 818 may be coupled to the second side of the one or more first thermoplastic/thermoplastic composite di-electric layers 812 via a first adhesive layer 814a. In various embodiments, a first side of the first carbon fiber composite layer 816 may be coupled to a second side, i.e., the plastic side, of the first metalized film humidity layer 818. In various embodiments, the first side of the first carbon fiber composite layer 816 may be coupled to the second side of the first metalized film humidity layer 818 via a second adhesive layer 814b.

In various embodiments, a first side of one or more second thermoplastic/thermoplastic composite di-electric layers 820 may be coupled to a second side of the second sheet 204. In various embodiments, no adhesive is used between the first side of the one or more second thermoplastic/thermoplastic composite di-electric layers 820 and the second side of the second sheet 204 because the first side of the one or more second thermoplastic/thermoplastic composite di-electric layers 820 may melt, during processing, and couple to the second side of the second sheet 204. In various embodiments, a first side of a second carbon fiber composite layer 822 may be coupled to a second side of the one or more second thermoplastic/thermoplastic composite di-electric layers 820. In various embodiments, the first side of the second carbon fiber composite layer 822 may be coupled to the second side of the one or more second thermoplastic/thermoplastic composite di-electric layers 820 via a third adhesive layer 814c. In various embodiments, a first side of a second metalized film humidity layer 824 may be coupled to a second side of the second carbon fiber composite layer 822. In various embodiments, the second metalized film humidity layer 824 may be comprised of a layer of polymeric plastic coated with a layer of one or more of titanium, stainless steel, nickel, or aluminum, among others, i.e., corrosion resistive materials. In various embodiments, the metal portion of the second metalized film humidity layer 824 is faced away from the second carbon fiber composite layer 822 to prevent corrosion. In various embodiments, the first side of the second metalized film humidity layer 824, i.e., the plastic side, may be coupled to the second side of the second carbon fiber composite layer 822 via a fourth adhesive layer 814d. In various embodiments, the first adhesive layer 814a, the second adhesive layer 814b, the third adhesive layer 814c, and the fourth adhesive layer 814d, may be an epoxy-based adhesive.

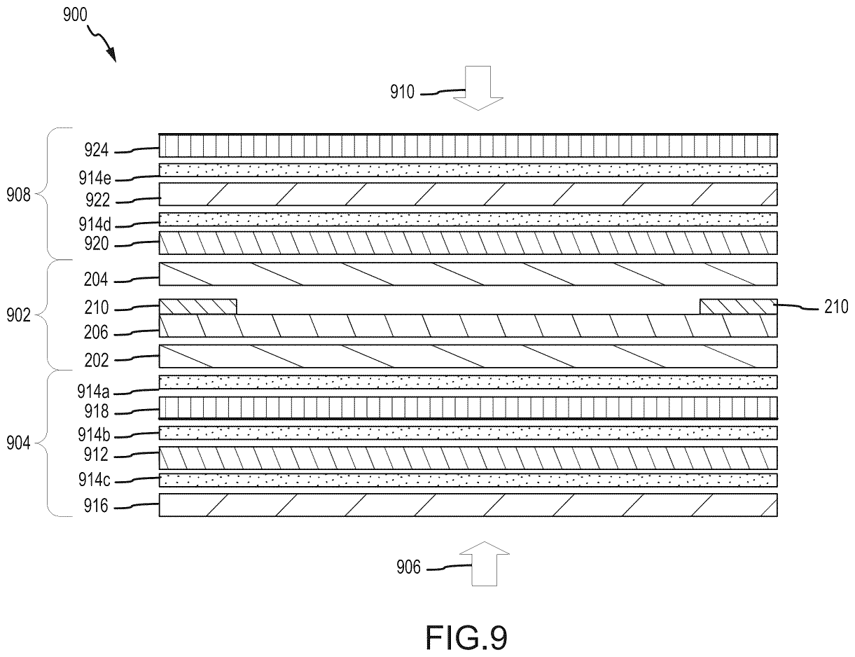

Referring to FIG. 9, in accordance with various embodiments, a cross-sectional view of CNT fabric composite heater assembly with the humidity protection shield, is illustrated. In various embodiments, the CNT fabric composite heater assembly with the humidity protection shield 900 includes CNT fabric composite heater assembly 902 that is similar to the CNT fabric composite heater assembly 200 of FIG. 2. In that regard, in various embodiments, a CNT sheet 206 is embedded in a first side of the first sheet 202. In various embodiments, the CNT sheet 206 may be routed in a desired pattern on the first side of the first sheet 202. Once embedded, in various embodiments, conductive wire leads are secured to both ends of the CNT sheet 206 via a coupling device 210. In various embodiments, the first side of the second sheet 204 is then coupled to the first side of the first sheet 202 such that the CNT sheet 206 and a portion of the conductive wire leads and/or the coupling device 210 are sandwiched between the first sheet 202 and the second sheet 204.

In various embodiments, the CNT fabric composite heater assembly 902 may be positioned within a humidity protection shield assembly. In various embodiments, the humidity protection shield assembly includes a first portion 904 on a leading edge or breeze side 906 and a second portion 908 on aerostructure or back side 910. In that regard, in various embodiments, the CNT fabric composite heater assembly 902 may be positioned between the first portion 904 and the second portion 908. In various embodiments, a first side of a first metalized film humidity layer 918 may be coupled to a second side of the first sheet 202. In various embodiments, the first metalized film humidity layer 918 may be comprised of a layer of polymeric plastic coated with a layer of one or more of titanium, stainless steel, nickel, or aluminum, among others, i.e., corrosion resistive materials. In various embodiments, the metal portion of the first metalized film humidity layer 918 is faced away from the first sheet 202 to prevent corrosion. In various embodiments, the first side, i.e., the plastic side, of the first metalized film humidity layer 918 may be coupled to the second side of the first sheet 202 via a first adhesive layer 914a. In various embodiments, a first side of one or more first thermoplastic/thermoplastic composite di-electric layers 912 may be coupled to a second side, i.e., the metal side, of the first metalized film humidity layer 918. In various embodiments, the first side of the one or more first thermoplastic/thermoplastic composite di-electric layers 912 may be coupled to the second side of the first metalized film humidity layer 918 via a second adhesive layer 914b. In various embodiments, a first side of the first carbon fiber composite layer 916 may be coupled to a second side of the one or more first thermoplastic/thermoplastic composite di-electric layers 912. In various embodiments, the first side of the first carbon fiber composite layer 916 may be coupled to the second side of the one or more first thermoplastic/thermoplastic composite di-electric layers 912 via a third adhesive layer 914c.

In various embodiments, a first side of one or more second thermoplastic/thermoplastic composite di-electric layers 920 may be coupled to a second side of the second sheet 204. In various embodiments, no adhesive is used between the first side of the one or more second thermoplastic/thermoplastic composite di-electric layers 920 and the second side of the second sheet 204 because the first side of the one or more second thermoplastic/thermoplastic composite di-electric layers 920 may melt, during processing, and couple to the second side of the second sheet 204. In various embodiments, a first side of a second carbon fiber composite layer 922 may be coupled to a second side of the one or more second thermoplastic/thermoplastic composite di-electric layers 920. In various embodiments, the first side of the second carbon fiber composite layer 922 may be coupled to the second side of the one or more second thermoplastic/thermoplastic composite di-electric layers 920 via a fourth adhesive layer 914d. In various embodiments, a first side of a second metalized film humidity layer 924 may be coupled to a second side of the second carbon fiber composite layer 922. In various embodiments, the second metalized film humidity layer 924 may be comprised of a layer of polymeric plastic coated with a layer of one or more of titanium, stainless steel, nickel, or aluminum, among others, i.e., corrosion resistive materials. In various embodiments, the metal portion of the second metalized film humidity layer 924 is faced away from the second carbon fiber composite layer 922 to prevent corrosion. In various embodiments, the first side, i.e., the plastic side, of the second metalized film humidity layer 924 may be coupled to the second side of the second carbon fiber composite layer 922 via a fifth adhesive layer 914e. In various embodiments, the first adhesive layer 914a, the second adhesive layer 914b, the third adhesive layer 914c, the fourth adhesive layer 914d, and the fifth adhesive layer 914e may be an epoxy-based adhesive.

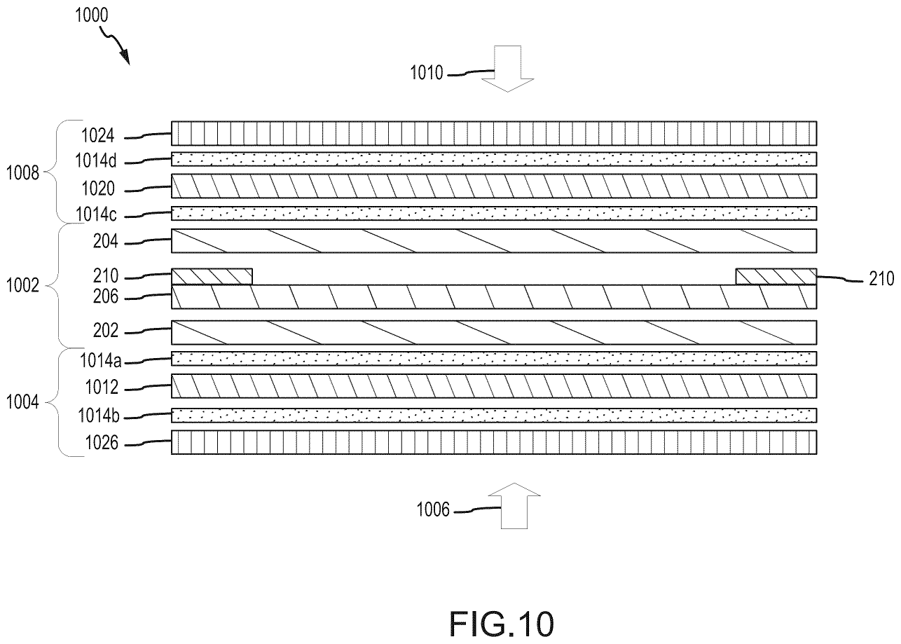

Referring to FIG. 10, in accordance with various embodiments, a cross-sectional view of CNT fabric composite heater assembly with the humidity protection shield, is illustrated. In various embodiments, the CNT fabric composite heater assembly with the humidity protection shield 1000 includes CNT fabric composite heater assembly 1002 that is similar to the CNT fabric composite heater assembly 200 of FIG. 2. In that regard, in various embodiments, a CNT sheet 206 is embedded in a first side of the first sheet 202. In various embodiments, the CNT sheet 206 may be routed in a desired pattern on the first side of the first sheet 202. Once embedded, in various embodiments, conductive wire leads are secured to both ends of the CNT sheet 206 via a coupling device 210. In various embodiments, the first side of the second sheet 204 is then coupled to the first side of the first sheet 202 such that the CNT sheet 206 and a portion of the conductive wire leads and/or the coupling device 210 are sandwiched between the first sheet 202 and the second sheet 204.

In various embodiments, the CNT fabric composite heater assembly 1002 may be positioned within a humidity protection shield assembly. In various embodiments, the humidity protection shield assembly includes a first portion 1004 on a leading edge or breeze side 1006 and a second portion 1008 on aerostructure or back side 1010. In that regard, in various embodiments, the CNT fabric composite heater assembly 1002 may be positioned between the first portion 1004 and the second portion 1008. In various embodiments, a first side of one or more first di-electric layers 1012 may be coupled to a second side of the first sheet 202. In various embodiments, the first side of the one or more first di-electric layers 1012 may be coupled to the second side of the first sheet 202 via a first adhesive layer 1014a. In various embodiments, a first side of a metallic leading edge/skin 1026 may be coupled to a second side of the one or more first di-electric layers 1012. In various embodiments, metallic leading edge/skin 1026 may be comprised of one or more of titanium, stainless steel, nickel, or aluminum, among others, i.e., corrosion resistive materials. In various embodiments, the metallic leading edge/skin 1026 is thicker than the metal humidity layers or metalized film humidity layers, discussed previously. In various embodiments, the metallic leading edge/skin 1026 may be coupled to the second side of the one or more first di-electric layers 1012 via a second adhesive layer 1014b.

In various embodiments, a first side of one or more second di-electric layers 1020 may be coupled to a second side of the second sheet 204. In various embodiments, the first side of the one or more second di-electric layers 1020 may be coupled to the second side of the second sheet 204 via a third adhesive layer 1014c. In various embodiments, a first side of a metal humidity layer 1024 may be coupled to a second side of the one or more second di-electric layers 1020. In various embodiments, the metal humidity layer 1024 may be comprised of one or more of titanium, stainless steel, nickel, or aluminum, among others, i.e., corrosion resistive materials. In various embodiments, the first side of the metal humidity layer 1024 may be coupled to the second side of the one or more second di-electric layers 1020 via a fourth adhesive layer 1014d. In various embodiments, the first adhesive layer 1014a, the second adhesive layer 1014b, the third adhesive layer 1014c, and the fourth adhesive layer 1014d, may be an epoxy-based adhesive.

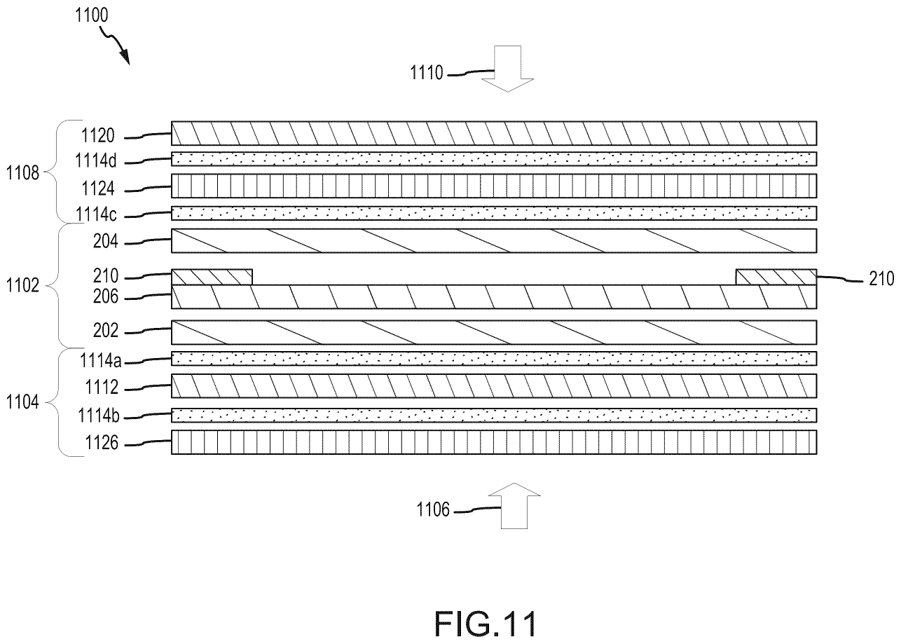

Referring to FIG. 11, in accordance with various embodiments, a cross-sectional view of CNT fabric composite heater assembly with the humidity protection shield, is illustrated. In various embodiments, the CNT fabric composite heater assembly with the humidity protection shield 1100 includes CNT fabric composite heater assembly 1102 that is similar to the CNT fabric composite heater assembly 200 of FIG. 2. In that regard, in various embodiments, a CNT sheet 206 is embedded in a first side of the first sheet 202. In various embodiments, the CNT sheet 206 may be routed in a desired pattern on the first side of the first sheet 202. Once embedded, in various embodiments, conductive wire leads are secured to both ends of the CNT sheet 206 via a coupling device 210. In various embodiments, the first side of the second sheet 204 is then coupled to the first side of the first sheet 202 such that the CNT sheet 206 and a portion of the conductive wire leads and/or the coupling device 210 are sandwiched between the first sheet 202 and the second sheet 204.

In various embodiments, the CNT fabric composite heater assembly 1102 may be positioned within a humidity protection shield assembly. In various embodiments, the humidity protection shield assembly includes a first portion 1104 on a leading edge or breeze side 1106 and a second portion 1108 on aerostructure or back side 1110. In that regard, in various embodiments, the CNT fabric composite heater assembly 1102 may be positioned between the first portion 1104 and the second portion 1108. In various embodiments, a first side of one or more first di-electric layers 1112 may be coupled to a second side of the first sheet 202. In various embodiments, the first side of the one or more first di-electric layers 1112 may be coupled to the second side of the first sheet 202 via a first adhesive layer 1114a. In various embodiments, a first side of a metallic leading edge/skin 1126 may be coupled to a second side of the one or more first di-electric layers 1112. In various embodiments, metallic leading edge/skin 1126 may be comprised of one or more of titanium, stainless steel, nickel, or aluminum, among others, i.e., corrosion resistive materials. In various embodiments, the metallic leading edge/skin 1126 is thicker than the metal humidity layers or metalized film humidity layers, discussed previously. In various embodiments, the metallic leading edge/skin 1126 may be coupled to the second side of the one or more first di-electric layers 1112 via a second adhesive layer 1114b.

In various embodiments, a first side of a metal humidity layer 1124 may be coupled to a second side of the second sheet 204. In various embodiments, the metal humidity layer 1124 may be comprised of one or more of titanium, stainless steel, nickel, or aluminum, among others, i.e., corrosion resistive materials. In various embodiments, the first side of the metal humidity layer 1124 may be coupled to the second side of the second sheet 204 via a third adhesive layer 1114c. In various embodiments, a first side of one or more second di-electric layers 1120 may be coupled to a second side of the metal humidity layer 1124. In various embodiments, the first side of the one or more second di-electric layers 1120 may be coupled to the second side of the metal humidity layer 1124 via a fourth adhesive layer 1114d. In various embodiments, the first adhesive layer 1114a, the second adhesive layer 1114b, the third adhesive layer 1114c, and the fourth adhesive layer 1114d, may be an epoxy-based adhesive.

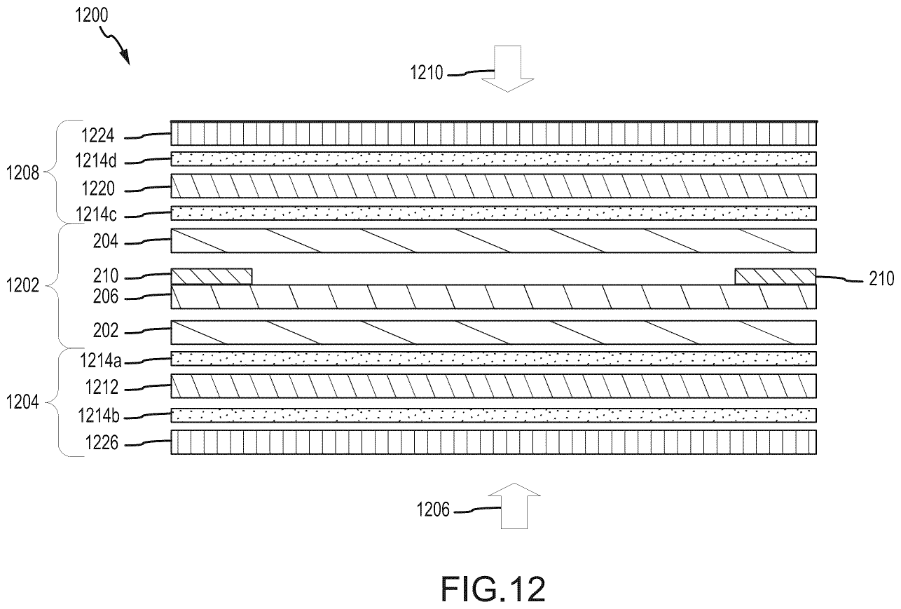

Referring to FIG. 12, in accordance with various embodiments, a cross-sectional view of CNT fabric composite heater assembly with the humidity protection shield, is illustrated. In various embodiments, the CNT fabric composite heater assembly with the humidity protection shield 1200 includes CNT fabric composite heater assembly 1202 that is similar to the CNT fabric composite heater assembly 200 of FIG. 2. In that regard, in various embodiments, a CNT sheet 206 is embedded in a first side of the first sheet 202. In various embodiments, the CNT sheet 206 may be routed in a desired pattern on the first side of the first sheet 202. Once embedded, in various embodiments, conductive wire leads are secured to both ends of the CNT sheet 206 via a coupling device 210. In various embodiments, the first side of the second sheet 204 is then coupled to the first side of the first sheet 202 such that the CNT sheet 206 and a portion of the conductive wire leads and/or the coupling device 210 are sandwiched between the first sheet 202 and the second sheet 204.

In various embodiments, the CNT fabric composite heater assembly 1202 may be positioned within a humidity protection shield assembly. In various embodiments, the humidity protection shield assembly includes a first portion 1204 on a leading edge or breeze side 1206 and a second portion 1208 on aerostructure or back side 1210. In that regard, in various embodiments, the CNT fabric composite heater assembly 1202 may be positioned between the first portion 1204 and the second portion 1208. In various embodiments, a first side of one or more first di-electric layers 1212 may be coupled to a second side of the first sheet 202. In various embodiments, the first side of the one or more first di-electric layers 1212 may be coupled to the second side of the first sheet 202 via a first adhesive layer 1214a. In various embodiments, a first side of a metallic leading edge/skin 1226 may be coupled to a second side of the one or more first di-electric layers 1212. In various embodiments, metallic leading edge/skin 1226 may be comprised of one or more of titanium, stainless steel, nickel, or aluminum, among others, i.e., corrosion resistive materials. In various embodiments, the metallic leading edge/skin 1226 is thicker than the metal humidity layers or metalized film humidity layers, discussed previously. In various embodiments, the metallic leading edge/skin 1226 may be coupled to the second side of the one or more first di-electric layers 1212 via a second adhesive layer 1214b.

In various embodiments, a first side of one or more second di-electric layers 1220 may be coupled to a second side of the second sheet 204. In various embodiments, the first side of the one or more second di-electric layers 1220 may be coupled to the second side of the second sheet 204 via a third adhesive layer 1214c. In various embodiments, a first side of a metalized film humidity layer 1224 may be coupled to a second side of the one or more second di-electric layers 1220. In various embodiments, the metalized film humidity layer 1224 may be comprised of a layer of polymeric plastic coated with a layer of one or more of titanium, stainless steel, nickel, or aluminum, among others, i.e., corrosion resistive materials. In various embodiments, the metal portion of the metalized film humidity layer 1224 is faced to an exterior of the CNT fabric composite heater assembly with the humidity protection shield 1200 to inhibit corrosion. In various embodiments, the first side, i.e., the plastic side, of the second film humidity layer 1224 may be coupled to the second side of the one or more second di-electric layers 1220 via a fourth adhesive layer 1214d. In various embodiments, the first adhesive layer 1214a, the second adhesive layer 1214b, the third adhesive layer 1214c, and the fourth adhesive layer 1214d, may be an epoxy-based adhesive.

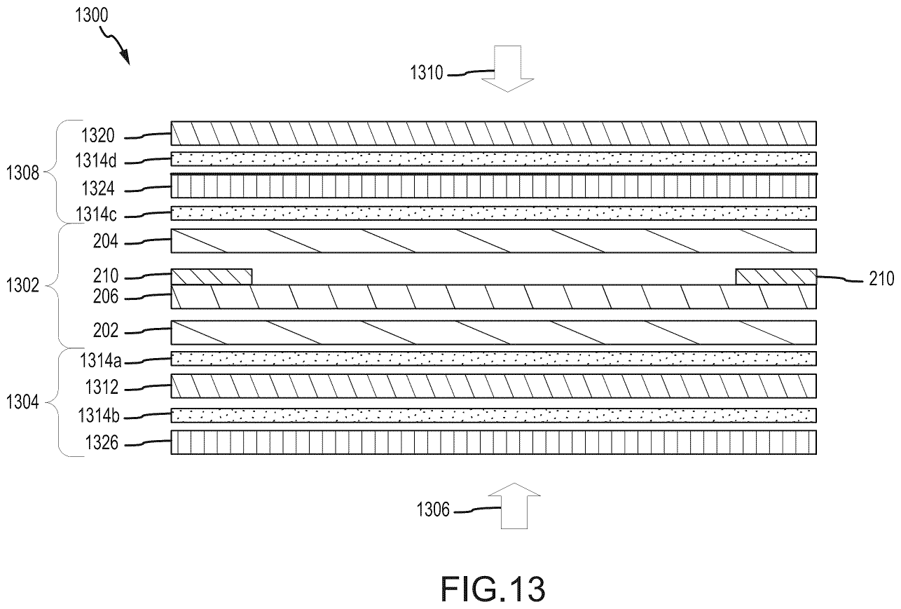

Referring to FIG. 13, in accordance with various embodiments, a cross-sectional view of CNT fabric composite heater assembly with the humidity protection shield, is illustrated. In various embodiments, the CNT fabric composite heater assembly with the humidity protection shield 1300 includes CNT fabric composite heater assembly 1302 that is similar to the CNT fabric composite heater assembly 200 of FIG. 2. In that regard, in various embodiments, a CNT sheet 206 is embedded in a first side of the first sheet 202. In various embodiments, the CNT sheet 206 may be routed in a desired pattern on the first side of the first sheet 202. Once embedded, in various embodiments, conductive wire leads are secured to both ends of the CNT sheet 206 via a coupling device 210. In various embodiments, the first side of the second sheet 204 is then coupled to the first side of the first sheet 202 such that the CNT sheet 206 and a portion of the conductive wire leads and/or the coupling device 210 are sandwiched between the first sheet 202 and the second sheet 204.

In various embodiments, the CNT fabric composite heater assembly 1302 may be positioned within a humidity protection shield assembly. In various embodiments, the humidity protection shield assembly includes a first portion 1304 on a leading edge or breeze side 1306 and a second portion 1308 on aerostructure or back side 1310. In that regard, in various embodiments, the CNT fabric composite heater assembly 1302 may be positioned between the first portion 1304 and the second portion 1308. In various embodiments, a first side of one or more first di-electric layers 1312 may be coupled to a second side of the first sheet 202. In various embodiments, the first side of the one or more first di-electric layers 1312 may be coupled to the second side of the first sheet 202 via a first adhesive layer 1314a. In various embodiments, a first side of a metallic leading edge/skin 1326 may be coupled to a second side of the one or more first di-electric layers 1312. In various embodiments, metallic leading edge/skin 1326 may be comprised of one or more of titanium, stainless steel, nickel, or aluminum, among others, i.e., corrosion resistive materials. In various embodiments, the metallic leading edge/skin 1326 is thicker than the metal humidity layers or metalized film humidity layers, discussed previously. In various embodiments, the metallic leading edge/skin 1326 may be coupled to the second side of the one or more first di-electric layers 1312 via a second adhesive layer 1314b.

In various embodiments, a first side of a metalized film humidity layer 1324 may be coupled to a second side of the second sheet 204. In various embodiments, the metalized film humidity layer 1324 may be comprised of a layer of polymeric plastic coated with a layer of one or more of titanium, stainless steel, nickel, or aluminum, among others, i.e., corrosion resistive materials. In various embodiments, the metal portion of the metalized film humidity layer 1324 is faced away from the second sheet 204 to prevent corrosion. In various embodiments, the first side, i.e., the plastic side, of the metalized film humidity layer 1324 may be coupled to the second side of the second sheet 204 via a third adhesive layer 1314c. In various embodiments, a first side of one or more second di-electric layers 1320 may be coupled to a second side, i.e., the metal side, of the metalized film humidity layer 1324. In various embodiments, the first side of the one or more second di-electric layers 1320 may be coupled to the second side of the metalized film humidity layer 1324 via a fourth adhesive layer 1314d. In various embodiments, the first adhesive layer 1314a, the second adhesive layer 1314b, the third adhesive layer 1314c, and the fourth adhesive layer 1314d, may be an epoxy-based adhesive.

Since CNT composite heaters for aircraft ice protection technology has shown great ice protection performance and have drawn great interests to multiple airframe companies, long-term resistance stability under environmental humidity is a key factor to CNT composite heater commercialization. Accordingly, the described humidity protection technology will facilitate light weight and green manufacture of CNT electrothermal ice protection systems.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 10%, within 5%, within 1%, within 0.1%, or within 0.01% of a stated value. Additionally, the terms “substantially,” “about” or “approximately” as used herein represent an amount close to the stated amount that still performs a desired function or achieves a desired result. For example, the term “substantially,” “about” or “approximately” may refer to an amount that is within 10% of, within 5% of, within 1% of, within 0.1% of, and within 0.01% of a stated amount or value.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. A humidity protection shield assembly for a carbon nanotube (CNT) fabric composite heater assembly, comprising:
the humidity protection shield assembly comprising a first portion and a second portion; and
the CNT fabric composite heater assembly disposed between the first portion and the second portion,
wherein the first portion comprising:
at least one of one or more first di-electric layers or one or more first thermoplastic/thermoplastic composite di-electric layers;
at least one of a first carbon fiber layer or a first composite carbon fiber layer; and
at least one of a first metal humidity layer or a first metalized film humidity layer, and
wherein the second portion comprising:
at least one of one or more second di-electric layers or one or more second thermoplastic/thermoplastic composite di-electric layers;
at least one of a second carbon fiber layer or a second composite carbon fiber layer; and
at least one of a second metal humidity layer or a second metalized film humidity layer.

2. The humidity protection shield assembly of claim 1,
wherein the first portion comprises:
a first side of the one or more first di-electric layers coupled to a first side of the CNT fabric composite heater assembly;
a first side of the first carbon fiber composite layer coupled to a second side of the one or more first di-electric layers; and
a first side of the first metal humidity layer coupled to a second side of the first carbon fiber composite layer, and
wherein the second portion comprises:
a first side of the one or more second di-electric layers coupled to a second side of the CNT fabric composite heater assembly;
a first side of the second carbon fiber composite layer coupled to a second side of the one or more second di-electric layers; and
a first side of the second metal humidity layer coupled to a second side of the second carbon fiber composite layer.

3. The humidity protection shield assembly of claim 1,
wherein the first portion comprises:
a first side of the one or more first thermoplastic/thermoplastic composite di-electric layers coupled to a first side of the CNT fabric composite heater assembly;
a first side of the first thermoplastic composite carbon fiber layer coupled to a second side of the one or more first thermoplastic/thermoplastic composite di-electric layers; and
a first side of the first metal humidity layer coupled to a second side of the first thermoplastic composite carbon fiber layer, and
wherein the second portion comprises:
a first side of the one or more second thermoplastic/thermoplastic composite di-electric layers may be coupled to a second side of the CNT fabric composite heater assembly;
a first side of the second thermoplastic composite carbon fiber layer coupled to a second side of the one or more second thermoplastic/thermoplastic composite di-electric layers; and
a first side of the second metalized film humidity layer may be coupled to a second side of the second thermoplastic composite carbon fiber layer.

4. The humidity protection shield assembly of claim 1,
wherein the first portion comprises:
a first side of the one or more first thermoplastic/thermoplastic composite di-electric layers coupled to a first side of the CNT fabric composite heater assembly;
a first side of the first carbon fiber composite layer coupled to a second side of the one or more first thermoplastic/thermoplastic composite di-electric layers; and
a first side of the first metalized film humidity layer coupled to a second side of the first carbon fiber composite layer, and
wherein the second portion comprises:
a first side of the one or more second thermoplastic/thermoplastic composite di-electric layers coupled to a second side of the CNT fabric composite heater assembly;
a first side of the second carbon fiber composite layer coupled to a second side of the one or more second thermoplastic/thermoplastic composite di-electric layers; and
a first side of the second metalized film humidity layer coupled to a second side of the second carbon fiber composite layer.

5. The humidity protection shield assembly of claim 1,
wherein the first portion comprises:
a first side of the one or more first thermoplastic/thermoplastic composite di-electric layers coupled to a first side of the CNT fabric composite heater assembly;
a first side of the first metalized film humidity layer coupled to a second side of the one or more first thermoplastic/thermoplastic composite di-electric layers; and
a first side of the first carbon fiber composite layer coupled to a second side of the first metalized film humidity layer, and
wherein the second portion comprises:
a first side of the one or more second thermoplastic/thermoplastic composite di-electric layers coupled to a second side of the CNT fabric composite heater assembly;
a first side of the second metalized film humidity layer coupled to a second side of the one or more second thermoplastic/thermoplastic composite di-electric layers; and
a first side of the second carbon fiber composite layer coupled to a second side of the second metalized film humidity layer.

6. The humidity protection shield assembly of claim 1,
wherein the first portion comprises:
a first side of the first metalized film humidity layer coupled to a first side of the CNT fabric composite heater assembly;
a first side of the one or more first thermoplastic/thermoplastic composite di-electric layers coupled to a second side of the first metalized film humidity layer; and
a first side of the first carbon fiber composite layer coupled to the second side of the one or more first thermoplastic/thermoplastic composite di-electric layers, and
wherein the second portion comprises:
a first side of the second metalized film humidity layer coupled to a second side of the CNT fabric composite heater assembly;
a first side of the one or more second thermoplastic/thermoplastic composite di-electric layers to a second side of the second metalized film humidity layer; and
a first side of the second carbon fiber composite layer coupled to the second side of the one or more second thermoplastic/thermoplastic composite di-electric layers.

7. The humidity protection shield assembly of claim 1,
wherein the first portion comprises:
a first side of the one or more first thermoplastic/thermoplastic composite di-electric layers coupled to a first side of the CNT fabric composite heater assembly;
a first side of the first metalized film humidity layer coupled to a second side of the one or more first thermoplastic/thermoplastic composite di-electric layers; and
a first side of the first carbon fiber composite layer coupled to the second side of the first metalized film humidity layer, and
wherein the second portion comprises:
a first side of the one or more second thermoplastic/thermoplastic composite di-electric layers coupled to a second side of the CNT fabric composite heater assembly;
a first side of the second carbon fiber composite layer coupled to a second side of the one or more second thermoplastic/thermoplastic composite di-electric layers; and
a first side of the second metalized film humidity layer coupled to a second side of the second carbon fiber composite layer.

8. The humidity protection shield assembly of claim 1,
wherein the first portion comprises:
a first side of the first metalized film humidity layer coupled to a first side of the CNT fabric composite heater assembly;
a first side of the one or more first thermoplastic/thermoplastic composite di-electric layers coupled to a second side of the first metalized film humidity layer; and
a first side of the first carbon fiber composite layer coupled to a second side of the one or more first thermoplastic/thermoplastic composite di-electric layers, and
wherein the second portion comprises:
a first side of the one or more second thermoplastic/thermoplastic composite di-electric layers coupled to a second side of the CNT fabric composite heater assembly;
a first side of the second carbon fiber composite layer coupled to a second side of the one or more second thermoplastic/thermoplastic composite di-electric layers; and
a first side of the second metalized film humidity layer coupled to a second side of the second carbon fiber composite layer.

9. The humidity protection shield assembly of claim 1, wherein the first metal humidity layer and the second metal humidity layer are each comprised of at least one of titanium, stainless steel, nickel, or aluminum.

10. The humidity protection shield assembly of claim 1, wherein the first metalized film humidity layer and the second metalized film humidity layer are each comprised of a layer of polymeric plastic coated with a metal and wherein the metal is at least one of a layer titanium, stainless steel, nickel, or aluminum.

11. The humidity protection shield assembly of claim 10, wherein, responsive to the first metalized film humidity layer being coupled to at least one of the first side of the CNT fabric composite heater assembly or the first thermoplastic composite carbon fiber layer, a metal side of the first metalized film humidity layer is faced away from the at least one of the first side of the CNT fabric composite heater assembly or the first thermoplastic composite carbon fiber layer.

12. The humidity protection shield assembly of claim 10, wherein, responsive to the second metalized film humidity layer being coupled to at least one of the second side of the CNT fabric composite heater assembly or the second thermoplastic composite carbon fiber layer, a metal side of the second metalized film humidity layer is faced away from the at least one of the second side of the CNT fabric composite heater assembly or the second thermoplastic composite carbon fiber layer.

13. A humidity protection shield assembly for a carbon nanotube (CNT) fabric composite heater assembly, comprising:
the humidity protection shield assembly comprising a first portion and a second portion; and
the CNT fabric composite heater assembly disposed between the first portion and the second portion,
wherein the first portion comprising:
a first side of one or more first di-electric layers coupled to a first side of the CNT fabric composite heater assembly; and
a first side of a metallic leading edge/skin coupled to a second side of the one or more first di-electric layers, and
wherein the second portion comprising:
one of one or more second di-electric layers; and
at least one of a metal humidity layer or a metalized film humidity layer.

14. The humidity protection shield assembly of claim 13,
wherein the second portion comprises:
a first side of the one or more second di-electric layers coupled to a second side of the CNT fabric composite heater assembly; and
a first side of the metal humidity layer coupled to a second side of the one or more second di-electric layers.

15. The humidity protection shield assembly of claim 13,
wherein the second portion comprises:
a first side of the metal humidity layer coupled to second side of the CNT fabric composite heater assembly; and
a first side of the one or more second di-electric layers coupled to a second side of the metal humidity layer.

16. The humidity protection shield assembly of claim 13,
wherein the second portion comprises:
a first side of the one or more second di-electric layers coupled to a second side of the CNT fabric composite heater assembly; and
a first side of the metalized film humidity layer coupled to a second side of the one or more second di-electric layers.

17. The humidity protection shield assembly of claim 13,
wherein the second portion comprises:
a first side of the metalized film humidity layer coupled to second side of the CNT fabric composite heater assembly; and
a first side of the one or more second di-electric layers coupled to a second side of the metalized film humidity layer.

18. The humidity protection shield assembly of claim 13, wherein the metal humidity layer is comprised of at least one of titanium, stainless steel, nickel, or aluminum.

19. The humidity protection shield assembly of claim 13, wherein the metalized film humidity layer is comprised of a layer of polymeric plastic coated with a metal and wherein the metal is at least one of a layer titanium, stainless steel, nickel, or aluminum.

20. The humidity protection shield assembly of claim 19, wherein, responsive to the metalized film humidity layer being coupled to the second side of the CNT fabric composite heater assembly, a metal side of the metalized film humidity layer is faced away from the second side of the CNT fabric composite heater assembly.
